(19) United States
(12) Patent Application Publication
(10) Pub. No.: US 2007/0146564 A1
(43) Pub. Date: Jun. 28, 2007

(54) ESD protection circuit and driving circuit for LCD

(75) Inventors: Hong Chi Wu, Miao-Li (TW); Yung-chang Chen, Miao-Li (TW); Chien-Ting Lai, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/317,502

(22) Filed: Dec. 23, 2005

(51) Int. Cl. G02F 1/1333

(52) U.S. Cl. 349/40

(57) ABSTRACT

An electrostatic discharge (ESD) protection circuit (140) includes: a first transistor (141), a second transistor (142), a third transistor (143), and a fourth transistor (144). Each transistor includes a source electrode ‘s’, a drain electrode ‘d’ and a gate electrode ‘g’. The gate electrode ‘g’ of the first transistor, the gate electrode ‘g’ of the second transistor, the drain electrode ‘d’ of the third transistor, and the drain electrode ‘d’ of the fourth transistor are connected to each other. The source electrode ‘s’ of the first transistor, the source electrode ‘s’ of the second transistor, and the source and gate electrodes of the third transistor are connected to each other. The drain electrode ‘d’ of the first transistor, the drain electrode ‘d’ of the second transistor, and the source and gate electrodes of the fourth transistor are connected to each other.

### TECHNICAL FIELD

The present invention relates to an electrostatic discharge (ESD) protection circuit, and more particularly to an ESD protection circuit for a thin film transistor liquid crystal display (TFT-LCD).

### BACKGROUND

A TFT-LCD has the advantages of portability, low power consumption, and low radiation, and has been widely used in various portable information products such as notebooks, personal digital assistants (PDAs), video cameras and the like. Furthermore, the TFT-LCD is considered by many to have the potential to completely replace CRT (cathode ray tube) monitors and televisions.

During a typical TFT-LCD fabricating process, static electricity may be generated on the TFT-LCD. If a large amount of electrical charge builds up at any one location on the TFT-LCD, the built up electrical charge is liable to discharge and thereby damage or destroy internal components of the TFT-LCD such as thin film transistors. To avoid the damaging effects of static electricity buildup and discharge during and after forming of the TFT-LCD array, a plurality of ESD protection circuits are employed in a typical TFT-LCD.

FIG. 3 is a schematic, abbreviated diagram of a layout of a conventional TFT-LCD having a plurality of ESD protection circuits. The TFT-LCD 200 includes a first substrate (not shown), a second substrate (not shown), and a liquid crystal layer (not shown) sandwiched between the two substrates. The first substrate includes a plurality of gate lines 210 that are parallel to each other and that each extend along a first direction, a plurality of data lines 220 that are parallel to each other and that each extend along a second direction orthogonal to the first direction, a first common electrode 230 formed at a periphery of the TFT-LCD 200, a plurality of gate line pads 211 formed at ends of the gate lines 210 respectively, a plurality of data line pads 221 formed at ends of the data lines 220 respectively, and a plurality of ESD protection circuits 240. The ends of the gate lines 210 and the ends of the data lines 220 are connected to the common electrode 230 through the ESD protection circuits 240. The second substrate includes a second common electrode (not shown) connected to the first common electrode 230 via a silver (Ag) dot.

FIG. 4 is a circuit diagram of an exemplary one of the ESD protection circuits 240 used in the TFT-LCD 200. The ESD protection circuit 240 includes a first transistor 241, a second transistor 242, a first terminal 245, and a second terminal 246. Each transistor 241, 242 includes a source electrode ‘s’, a drain electrode ‘d’, and a gate electrode ‘g’. The source electrode ‘s’ and gate electrode ‘g’ of the transistor 241 are connected to each other, and the source electrode ‘s’ and gate electrode ‘g’ of the transistor 242 are connected to each other. The source electrode ‘s’ of the first transistor 241 and the drain electrode ‘d’ of the second transistor 242 are connected together to define the first terminal 245. The drain electrode ‘d’ of the first transistor 241 and the source electrode ‘s’ of the second transistor 242 are connected together to define the second terminal 246. The first terminal 245 is connected to one of the gate lines 210 or one of the data lines 220. The second terminal 246 is connected to the common electrode 230.

Generally, operation of the ESD protection circuit 240 is as follows. When positive charge generated by an ESD flows from the first terminal 245, the first transistor 241 is turned on and the positive charge on the first terminal 245 flows to the common electrode 230 via the second terminal 246. When negative charge generated by an ESD flows from the first terminal 245, the second transistor 242 is turned on and the negative charge on the first terminal 245 flows to the common electrode 230 via the second terminal 246. Thus, the ESD protection circuit 240 can prevent static electricity generated in the process of fabricating the gate lines 210 or the data line 220 of TFT-LCD 200 from destroying other internal circuits (not shown) of the TFT LCD 200.

On the other hand, if built-up electrical charge does not flow from the first terminal 245, then the first and second transistors 241, 242 are maintained in an off state. In this state, the ESD protection circuit 240 blocks the electrical path between the first terminal 245 and the second terminal 246 to insulate the first terminal 245 and the second terminal 246 from each other.

When the electrical charge generated by an ESD flows from the first terminal 245, only one current path can be formed between the first terminal 245 and the second terminal 246 at any one time. That is, the current path is either through the first transistor 241 or the second transistor 242. However, the current of electrical charge may be so large that it destroys one of the transistors 241, 242. If one of the transistors 241, 242 is destroyed by the discharge current, the corresponding current path between the first terminal 245 and the second terminal 246 cannot be formed. Thus, a subsequent discharge of static electricity generated in the process of fabricating the gate line 210 or the data line 220 may destroy other internal circuits of the TFT-LCD 200.

FIG. 5 is a circuit diagram of an alternative exemplary ESD protection circuit 260 that can be used in the TFT-LCD 200, instead of using the ESD protection circuits 240. The ESD protection circuit 260 includes a first transistor 261, a second transistor 262, a third transistor 263, a fourth transistor 264, a first terminal 265, and a second terminal 266. Each transistor 261, 262, 263, 264 includes a source electrode ‘s’, a drain electrode ‘d’, and a gate electrode ‘g’. The source electrode ‘s’ and the gate electrode ‘g’ of the first transistor 261 are connected to each other. The source electrode ‘s’ and the gate electrode ‘g’ of the second transistor 262 are connected to each other. The drain electrode ‘d’ of the first transistor 261 is connected to the source electrode ‘s’ of the second transistor 262 to define a node 267. The source electrode ‘s’ and the gate electrode ‘g’ of the third transistor 263 are connected to each other. The source electrode ‘s’ and the gate electrode ‘g’ of the fourth transistor 264 are connected to each other. The source electrode ‘s’ of the third transistor 263 is connected to the drain electrode ‘d’ of the fourth transistor 264 to define a node 268. The source electrode ‘s’ of the first transistor 261 and the drain electrode ‘d’ of the third transistor 263 are connected together to define the first terminal 265. The drain electrode ‘d’ of the second transistor 262 and the source electrode ‘s’ of the fourth transistor 264 are connected together to define the second terminal 266. The first terminal 265 is connected to one of the gate lines 210 or one of the data lines 220. The second terminal 266 is connected to the common electrode 230.

Generally, operation of the ESD protection circuit 260 is as follows. When positive charge generated by an ESD flows from the first terminal 265, the voltage of the first terminal 265 is much higher than the voltage of the node 267. Thus the first transistor 261 is turned on, and the positive charge on the first terminal 265 flows through the first transistor 261 to charge the gate electrode ‘g’ of the second transistor 262. Then the second transistor 262 is turned on and the positive charge flows to the common electrode 230 via the second terminal 266. When negative charge generated by an ESD flows from the first terminal 265, the voltage of the first terminal 265 is much lower than the voltage of the node 268. Thus the third transistor 263 is turned on, and the negative charge on the first terminal 265 flows through the first transistor 263 to charge the node 268. Then the voltage of the second terminal 266 is much higher than the voltage of the node 268. Thus the fourth transistor 264 is turned on, and the negative charge flows to the common electrode 230 via the second terminal 266.

On the other hand, if built-up electrical charge does not flow from the first terminal 265, then the first, second, third and fourth transistors 261, 262, 263, 264 are maintained in an off state. In this state, the ESD protection circuit 260 blocks the electrical path between the first terminal 265 and the second terminal 266 to insulate the first terminal 265 and the second terminal 266 from each other.

However, the ESD protection circuit 260 is subject to the same kind of problem as that described above in relation to the ESD protection circuit 240. That is, a large current of electrical charge may destroy one of the transistors 261, 262, 263, 264. Thus, a subsequent discharge of static electricity generated in the process of fabricating the gate line 210 or the data line 220 may destroy other internal circuits of the TFT-LCD 200.

It is desired to provide an ESD protection circuit which overcomes the above-described deficiencies.

### SUMMARY

An ESD protection circuit includes a first transistor including a source electrode, a drain electrode and a gate electrode; a second transistor including a source electrode, a drain electrode and a gate electrode; a third transistor including a source electrode, a drain electrode and a gate electrode; and a fourth transistor including a source electrode, a drain electrode and a gate electrode. The gate electrode of the first transistor, the gate electrode of the second transistor, the drain electrode of the third transistor, and the drain electrode of the fourth transistor are connected to each other. The source electrode of the first transistor, the source electrode of the second transistor, and the source and gate electrodes of the third transistor are connected to each other. The drain electrode of the first transistor, the drain electrode of the second transistor, and the source and gate electrodes of the fourth transistor are connected to each other.

A driving circuit of a TFT-LCD includes a plurality of gate lines that are parallel to each other and that each extend along a first direction; a plurality of data lines that are parallel to each other and that each extend along a second direction orthogonal to the first direction; a common electrode; and a plurality of ESD protection circuits, each ESD protection circuits including: a first terminal which is connected to the gate line or the data line; a second terminal which is connected to the common electrode; a first transistor including a source electrode, a drain electrode and a gate electrode; a second transistor including a source electrode, a drain electrode and a gate electrode; a third transistor including a source electrode, a drain electrode and a gate electrode; and a fourth transistor including a source electrode, a drain electrode and a gate electrode. The gate electrode of the first transistor, the gate electrode of the second transistor, the drain electrode of the third transistor, and the drain electrode of the fourth transistor are connected to each other. The source electrode of the first transistor, the source electrode of the second transistor, and the source and gate electrodes of the third transistor are connected to the first terminal. The drain electrode of the first transistor, the drain electrode of the second transistor, and the source and gate electrodes of the fourth transistor are connected to the second terminal.

Advantages and novel features of the above-described circuits will become more apparent from the following detailed description when taken in conjunction with the accompanying drawings, in which:

### BRIEF DESCRIPTION OF THE DRAWINGS

FIG. 1 is a schematic, abbreviated diagram of a layout of a TFT-LCD having a plurality of ESD protection circuits according to a preferred embodiment of the present invention;

FIG. 2 is a circuit diagram of an exemplary one of the ESD protection circuits used in the TFT-LCD of FIG. 1;

FIG. 3 is a schematic, abbreviated diagram of a layout of a conventional TFT-LCD having a plurality of ESD protection circuits;

FIG. 4 is a circuit diagram of an exemplary one of the ESD protection circuits used in the TFT-LCD of FIG. 3; and

FIG. 5 is a circuit diagram of an alternative exemplary ESD protection circuit that can be used in the TFT-LCD of FIG. 3.

### DETAILED DESCRIPTION OF PREFERRED EMBODIMENTS

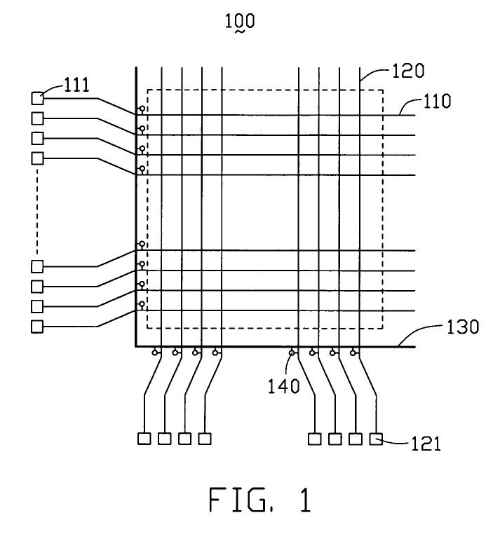

FIG. 1 is an abbreviated layout of a TFT-LCD having a plurality of ESD protection circuits according to a preferred embodiment of the present invention. The TFT-LCD 100 includes a first substrate (not shown), a second substrate (not shown), and a liquid crystal layer (not shown) sandwiched between the two substrates. The first substrate includes a plurality of gate lines 110 that are parallel to each other and that each extend along a first direction, a plurality of data lines 120 that are parallel to each other and that each extend along a second direction orthogonal to the first direction, a first common electrode 130 formed at a periphery of the TFT-LCD 100, a plurality of gate line pads 11 formed at ends of the gate lines 110 respectively, a plurality of data line pads 121 formed at ends of the data lines 120 respectively, and a plurality of ESD protection circuits 140. The ends of the gate lines 110 and the ends of the data lines 120 are connected to the common electrode 130 through the ESD protection circuits 140. The second substrate includes a second common electrode (not shown) connected to the first common electrode 130 via a silver (Ag) dot.

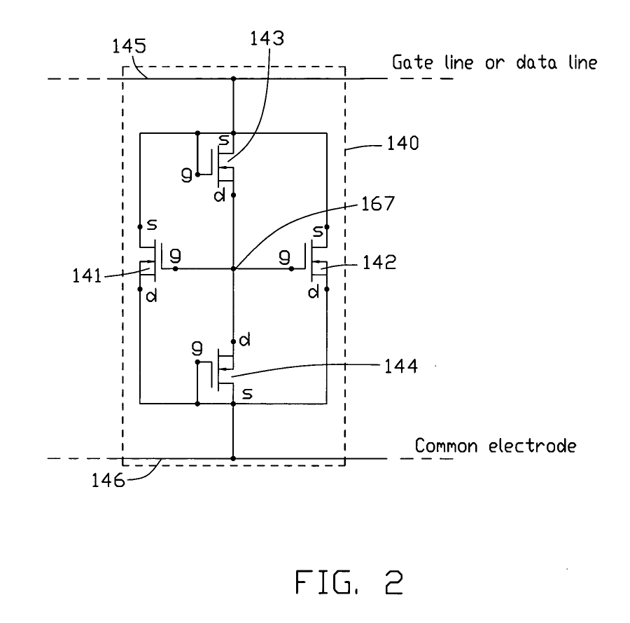

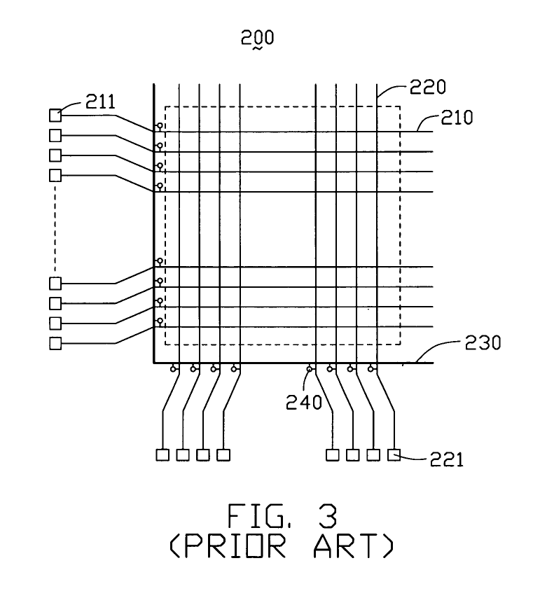

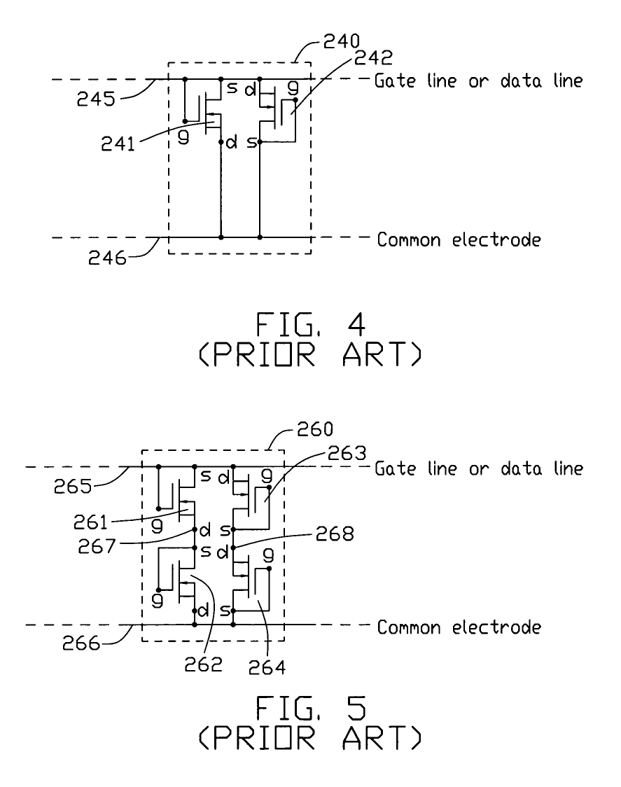

FIG. 2 is a circuit diagram of an exemplary one of the ESD protection circuits 140 used in the TFT-LCD 100. The ESD protection circuit 140 includes a first transistor 141, a second transistor 142, a third transistor 143, a fourth transistor 144, a first terminal 145, and a second terminal 146. Each transistor 141, 142, 143, 144 includes a source electrode ‘s’, a drain electrode ‘d’, and a gate electrode ‘g’.

The gate electrode ‘g’ of the first transistor 141 is connected to the gate electrode ‘g’ of the second transistor 142 to define a crunode 167. The source electrode ‘s’ of the first transistor 141 and the source electrode ‘s’ of the second transistor 142 are connected together to define the first terminal 145. The drain electrode ‘d’ of the first transistor 141 and drain electrode ‘d’ of the second transistor 142 are connected together to define the second terminal 146. The first and second transistors 141, 142 function as electrostatic discharge elements.

The drain electrode ‘d’ of the third transistor 143 and the drain electrode ‘d’ of fourth transistor 144 are both connected to the crunode 167. The source electrode ‘s’ and the gate electrode ‘g’ of the third transistor 143 are connected to the first terminal 145. The source electrode ‘s’ and the gate electrode ‘g’ of the fourth transistor 144 are connected to the second terminal 146. The third and fourth transistors 143, 144 function as control elements. The first transistor 141, the second transistor 142, the third transistor 143, and the fourth transistor 144 may be positive metal-oxide semiconductor (PMOS) transistors, negative metal-oxide semiconductor (NMOS) transistors, or thin film transistors. The first terminal 145 is connected to one of the gate lines 110 or one of the data lines 120. The second terminal 146 is connected to the common electrode 130.

Generally, operation of the ESD protection circuit 140 is as follows. When electrical charge generated by an ESD flows from the first terminal 145, the third transistor 143 is turned on. The electrical charge at the first terminal 145 flows through the third transistor 143 to charge the crunode 167. Because the gate electrodes ‘g’ of the first and second transistors 141, 142 are connected to the crunode 167, the first and second transistors 141, 142 are turned on, and the electrical charge flows to the common electrode 130 via the second terminal 146.

Unlike with the conventional ESD protection circuits 240, 260 described above, in the ESD protection circuit 140, when electrical charge generated by an ESD flows from the first terminal 145, the ESD protection circuit 140 can form two current paths between the first terminal 145 and the second terminal 146. That is, the current paths are through the first transistor 141 and the second transistor 142. Thus a maximum current of electrical charge that the ESD protection circuit 140 can tolerate without sustaining damage is larger. Furthermore, even if a current of electrical charge damages or destroys one of the transistors 141, 142, a current path can still be formed between the first terminal 145 and the second terminal 146 via the other of the transistors 141, 142. Thus, the ESD protection circuit 140 can prevent static electricity generated in the process of fabricating the gate lines 110 or the data lines 120 from destroying other internal circuits (not shown) of the TFT-LCD 100.

In alternative applications, the ESD protection circuit 140 can be used in other electronic devices such as at an input pad of an integrated circuit.

It is to be understood, however, that even though numerous characteristics and advantages of preferred embodiments have been set out in the foregoing description, together with details of the structures and functions of the embodiments, the disclosure is illustrative only; and that changes may be made in detail, especially in matters of shape, size, and arrangement of parts within the principles of present invention to the full extent indicated by the broad general meaning of the terms in which the appended claims are expressed.

What is claimed is:

1. An electrostatic discharge (ESD) protection circuit comprising:
a first transistor comprising a source electrode, a drain electrode, and a gate electrode;
a second transistor comprising a source electrode, a drain electrode, and a gate electrode;
a third transistor comprising a source electrode, a drain electrode, and a gate electrode; and
a fourth transistor comprising a source electrode, a drain electrode, and a gate electrode;
wherein the gate electrode of the first transistor, the gate electrode of the second transistor, the drain electrode of the third transistor, and the drain electrode of the fourth transistor are connected to each other;
the source electrode of the first transistor, the source electrode of the second transistor, and the source and gate electrodes of the third transistor are connected to each other; and
the drain electrode of the first transistor, the drain electrode of the second transistor, and the source and gate electrodes of the fourth transistor are connected to each other.

2. The ESD protection circuit as claimed in claim 1, further comprising a terminal connected to the source electrode of the first transistor.

3. The ESD protection circuit as claimed in claim 1, further comprising a terminal connected to the drain electrode of the first transistor.

4. The ESD protection circuit as claimed in claim 1, wherein the first transistor, the second transistor, the third transistor, and the fourth transistor are positive metal-oxide semiconductor (PMOS) transistors.

5. The ESD protection circuit as claimed in claim 1, wherein the first transistor, the second transistor, the third transistor, and the fourth transistor are negative metal-oxide semiconductor (NMOS) transistors.

6. The ESD protection circuit as claimed in claim 1, wherein the first transistor, the second transistor, the third transistor, and the fourth transistor are thin film transistors.

7. The ESD protection circuit as claimed in claim 1, wherein the first and second transistors constitute electrostatic discharge elements.

8. The ESD protection circuit as claimed in claim 1, wherein the third and fourth transistors constitute control elements.

9. A driving circuit for a thin film transistor liquid crystal display (TFT-LCD), comprising:
a plurality of gate lines that are parallel to each other and that each extend along a first direction;
a plurality of data lines that are parallel to each other and that each extend along a second direction orthogonal to the first direction;
a common electrode;
a plurality of electrostatic discharge (ESD) protection circuits, each ESD protection circuit comprising:
a first terminal which is connected to a respective one of the gate lines or a respective one of the data lines;
a second terminal which is connected to the common electrode;
a first transistor comprising a source electrode, a drain electrode, and a gate electrode;
a second transistor comprising a source electrode, a drain electrode, and a gate electrode;
a third transistor comprising a source electrode, a drain electrode, and a gate electrode; and
a fourth transistor comprising a source electrode, a drain electrode, and a gate electrode;
wherein the gate electrode of the first transistor, the gate electrode of the second transistor, the drain electrode of the third transistor, and the drain electrode of the fourth transistor are connected to each other;
the source electrode of the first transistor, the source electrode of the second transistor, and the source and gate electrodes of the third transistor are connected to the first terminal; and
the drain electrode of the first transistor, the drain electrode of the second transistor, and the source and gate electrodes of the fourth transistor are connected to the second terminal.
